(19) United States
(12) Patent Application Publication
(10) Pub. No.: US 2016/0349860 A1
(43) Pub. Date: Dec. 1, 2016

(54) DISPLAY CONTROL METHOD, DISPLAY CONTROL PROGRAM, AND DISPLAY CONTROL DEVICE

(71) Applicant: Konica Minolta, Inc., Tokyo (JP)

(72) Inventors: Yoshifumi WAGATSUMA, Tokyo (JP); Katsutoshi SAWADA, Tokyo (JP)

(21) Appl. No.: 15/151,113

(22) Filed: May 10, 2016

(30) Foreign Application Priority Data
May 29, 2015 (JP) 2015-110707

(51) Int. Cl. G06F 3/0362; G06F 3/0484

(52) U.S. Cl. CPC G06F 3/0362; G06F 3/04847

(57) ABSTRACT

A display control method implemented in a system capable of conducting two or more processes on a single display unit includes: an operation receiving step of receiving an operation for switching a screen display between screens for using the respective processes; a threshold value setting step of setting a threshold value in accordance with progress of each corresponding one of the processes, the threshold value being for determining whether to switch the screen display in accordance with a level of the operation; and a display switching step of switching the screen display when the level of the operation received in the operation receiving step satisfies a criterion determined by the threshold value.

The entire disclosure of Japanese Patent Application No. 2015-110707 filed on May 29, 2015 including description, claims, drawings, and abstract are incorporated herein by reference in its entirety.

### BACKGROUND OF THE INVENTION

Field of the Invention

The present invention relates to a display control method, a display control program, and a display control device.

Description of the Related Art

There have been technologies for conducting more than one process in one electronic apparatus, and technologies for conducting more than one process in a system formed with a combination of electronic apparatuses. According to one of such technologies, screens for using the respective processes are displayed on a single display unit, and the processes are controlled on the single display unit, so as to increase user-friendliness and reduce the number of components (see JP 2014-89493 A).

According to the technology disclosed in JP 2014-89493 A, a user presses the button corresponding to a desired process among the buttons that correspond to the respective processes and are displayed on the menu screen of the display unit. As a result, the screen display is switched to the screen for using the desired process, and the user can conduct the process through this screen. As switching the screen display to a screen for using a desired process invariably involves pressing of a button, a user can easily select and use each process.

In an apparatus that performs more than one process as described above, however, there are cases that the operation to switch the screen display to a screen for using a desired process is desirably not the same all the time for reasons such as a user's liking, the developer's intention, or the vendor's strategy. For example, the developer's intention or the vendor's strategy may be that a user is to be guided to a process flow in which a process is performed after a certain process is completed, as an excellent effect can be expected when processes are performed in a specific order. By the technology disclosed in JP 2014-89493 A, however, a user does not have any guidance, and can freely select processes by the same operation. As a result, a user might conduct processes in an undesirable order, or in a sequence not intended by the developer or the vendor.

### SUMMARY OF THE INVENTION

The present invention has been made in view of those circumstances, and an object thereof is to provide a display control method, a display control program, and a display control device for guiding a user to an ideal process flow by using different operations to switch screens for processes in an apparatus that performs the processes.

The above object is achieved with the following structures.

(1) To achieve the abovementioned object, according to an aspect, a display control method implemented in a system capable of conducting two or more processes on a single display unit reflecting one aspect of the present invention comprises: an operation receiving step of receiving an operation for switching a screen display between screens for using the respective processes; a threshold value setting step of setting a threshold value in accordance with progress of each corresponding one of the processes, the threshold value being for determining whether to switch the screen display in accordance with a level of the operation; and a display switching step of switching the screen display when the level of the operation received in the operation receiving step satisfies a criterion determined by the threshold value.

(2) The display control method of Item. 1, wherein the threshold value setting step preferably includes changing the threshold value for switching the screen display from a screen for using one process to a screen for using another process, to enable the screen display to be switched more readily after the one process is used than before the one process is used.

(3) The display control method of Item. 1 or 2, preferably further comprising a threshold value receiving step of receiving a change of the threshold value from a user.

(4) The display control method of anyone of Items. 1 to 3, preferably further comprising an operating state changing step of changing an operating state of an apparatus performing a process to be used through a screen after the switching of the screen display in the display switching step.

(5) The display control method of Item. 4, wherein the operating state changing step preferably includes changing the operating state of the apparatus after a predetermined time has passed since the switching of the screen display.

(6) The display control method of Item. 5, preferably further comprising a time setting step of setting the predetermined time in accordance with progress of the process.

(7) The display control method of Item. 5 or 6, preferably further comprising a time receiving step of receiving a change of the predetermined time from a user.

(8) The display control method of Item. 6 or 7, wherein the time setting step preferably includes setting the predetermined time at a smaller value after the process to be used through the screen prior to the switching is performed than before the process to be used through the screen prior to the switching is performed.

(9) The display control method of Item. 6 or 7, wherein the time setting step preferably includes setting the predetermined time at a greater value after the process to be used through the screen prior to the switching is performed than before the process to be used through the screen prior to the switching is performed.

(10) The display control method of any one of Items. 1 to 9, wherein the switching of the screen display preferably includes at least one of changing an area occupied by each screen on the display unit, changing permission of reception of an operation through each screen, highlighting a specific screen, changing luminance of a specific screen, and changing a positional relationship between a specific screen and another screen.

(11) The display control method of any one of Items. 1 to 10, wherein the operation preferably includes at least one of an operation with a touch input or a flick input on a touch panel, an operation with a line of sight, an operation with voice, an operation with motion capture, an operation with hardware keys, and an operation through communication with an external electronic device.

(12) The display control method of any one of Items. 1 to 11, wherein the display switching step preferably includes switching the screen display to a screen for using one process, when the screen for using the one process is set as a normal display screen, and any process is not performed over a certain period of time while the screen for using another process is displayed.

(13) To achieve the abovementioned object, according to an aspect, a non-transitory recording medium storing a computer readable program reflecting one aspect of the present invention causes a computer to implement the display control method of any one of Items. 1 to 12.

(14) To achieve the abovementioned object, according to an aspect, a display control device for controlling a system capable of conducting two or more processes on the same display unit reflecting one aspect of the present invention comprises: an operation receiving unit configured to receive an operation for switching a screen display between screens for using the respective processes; a threshold value setting unit configured to set a threshold value in accordance with progress of a process, the threshold value being for determining whether to switch the screen display in accordance with a level of the operation; and a display switching unit configured to switch the screen display when the level of the operation received by the operation receiving unit satisfies a criterion determined by the threshold value.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram schematically showing the structure of a display system according to a first embodiment;

FIG. 2 is a block diagram showing the hardware configuration of the automatic vending machine shown in FIG. 1;

FIG. 3 is a block diagram showing the hardware configuration of the image forming apparatus shown in FIG. 1;

FIGS. 4A to 4C are diagrams for explaining an example of a screen display switching method;

FIG. 5A is a flowchart showing the procedures in a display control process to be performed in the display system;

FIG. 5B is a flowchart continuing from FIG. 5A;

FIG. 6 is a diagram for explaining an example of a threshold value changing process;

FIG. 7 is a diagram for explaining an example of a start-up time changing process;

FIG. 8 is a diagram for explaining another example of a start-up time changing process;

FIG. 9 is a diagram for explaining another example of a screen display switching method;

FIG. 10 is a diagram for explaining yet another example of a screen display switching method;

FIG. 11 is a diagram for explaining still another example of a screen display switching method;

FIGS. 12A to 12C are diagrams for explaining yet another example of a screen display switching method;

FIG. 13 is a block diagram showing the hardware configuration of a display system according to a second embodiment; and

FIG. 14 is a block diagram showing the functional structure of the image forming apparatus shown in FIG. 13.

### DESCRIPTION OF THE PREFERRED EMBODIMENTS

Hereinafter, an embodiment of the present invention will be described with reference to the drawings. However, the scope of the invention is not limited to the illustrated examples. In the description below with reference to the drawings, like components are denoted by like reference numerals, and explanation of those components will not be repeated twice or more. Further, the dimensional ratios in the drawings are magnified for ease of explanation, and may differ from the actual dimensional ratios.

### First Embodiment

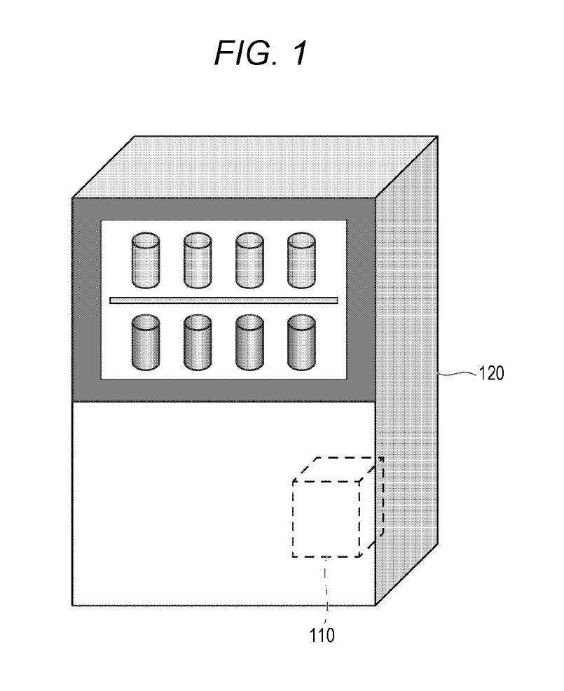

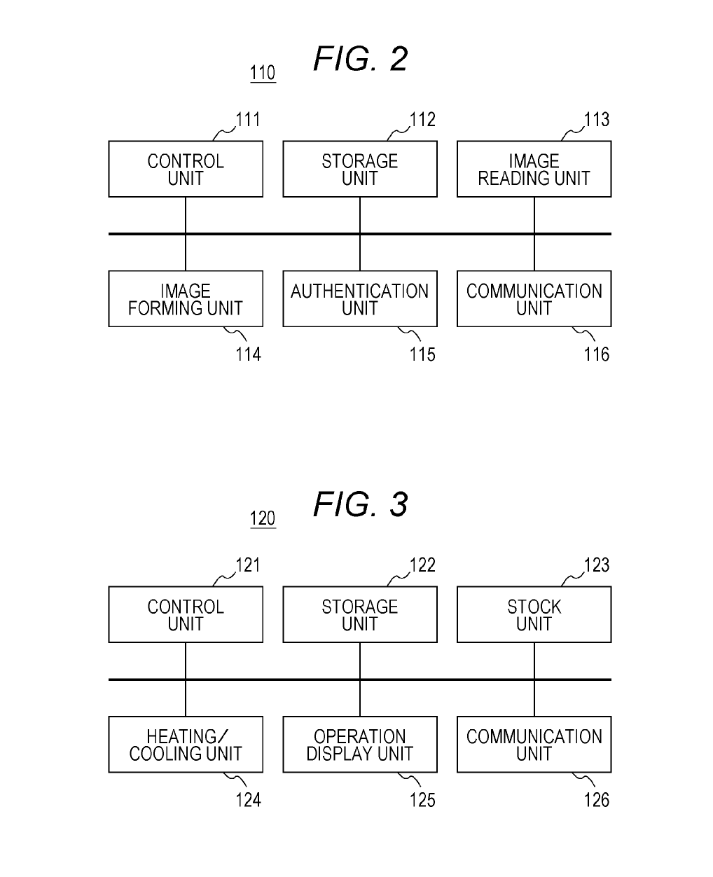

FIG. 1 is a diagram schematically showing the structure of a display system according to a first embodiment of the present invention. FIG. 2 is a block diagram showing the hardware configuration of the automatic vending machine shown in FIG. 1. FIG. 3 is a block diagram showing the hardware configuration of the image forming apparatus shown in FIG. 1.

As shown in FIG. 1, the display system includes an image forming apparatus 110 and an automatic vending machine 120. The image forming apparatus 110 is incorporated into the housing of the automatic vending machine 120, and communicates with the automatic vending machine 120 in a bidirectional manner. In this embodiment, the automatic vending machine 120 is the master apparatus that controls the entire system in accordance with instructions from users. The image forming apparatus 110 is a slave apparatus that operates in accordance with instructions from the automatic vending machine 120, which is the master apparatus. In the description below, the respective components are described.

<Image Forming Apparatus 110>

As shown in FIG. 2, the image forming apparatus 110 includes a control unit 111, a storage unit 112, an image reading unit 113, an image forming unit 114, an authentication unit 115, and a communication unit 116. These components are connected to one another via a bus designed for exchanging signals.

The control unit 111 is a CPU (Central Processing Unit). The control unit 111 controls the above mentioned components of the image forming apparatus 110 and performs various arithmetic processes in accordance with programs stored in the storage unit 112.

The storage unit 112 includes a ROM (Read Only Memory) that stores various programs and various kinds of data in advance, a RAM (Random Access Memory) that serves as a work area to temporarily store programs and data, and a hard disk or the like that stores various programs and various kinds of data.

The image reading unit 113 is a device for generating image data from an original image shown on a paper medium or the like, and includes an imaging device such as a CCD (Charge Coupled Device) image sensor. The image reading unit 113 irradiates an original image with light from a light source such as a fluorescent lamp, photoelectrically converts the reflected light with the imaging device, and generates image data from the obtained electrical signal.

The image forming unit 114 forms an image based on the image data on a recording medium such as a paper sheet, using a known image forming process such as an electrophotographic process or an inkjet process.

The authentication unit 115 includes a card reader or the like compliant with near field communication standards such as NFC (Near Field Communication), and has a function to identify personal information about a user by reading information from a card carried by the user. The authentication unit 115 can also perform user authentication or access management or the like by transmitting the user's personal information to an authentication server or the like, in conjunction with an authentication program stored in the storage unit 112.

The communication unit 116 is an interface for communicating with another device in a wired or wireless manner. The communication unit 116 exchanges various kinds of information, such as instructions and setting values related to device control, with the automatic vending machine 120.

In this embodiment, the image forming apparatus 110 is incorporated into the housing of the automatic vending machine 120. Therefore, the image forming apparatus 110 has neither an operation unit to receive user operations and nor display unit for displaying an operating screen. The image forming apparatus 110 is operated via a screen or a like displayed on the automatic vending machine 120. The control unit 111 of the image forming apparatus 110 receives instructions transmitted from the automatic vending machine 120 via the communication unit 116, and controls the image forming apparatus 110 in accordance with the received instructions.

<Automatic Vending Machine 120>

As shown in FIG. 3, the automatic vending machine 120 includes a control unit 121, a storage unit 122, a stock unit 123, a heating/cooling unit 124, an operation display unit 125, and a communication unit 126. These components are connected to one another via a bus designed for exchanging signals. The storage unit 122 and the communication unit 126 of the automatic vending machine 120 have the same functions as the storage unit 112 and the communication unit 116 of the image forming apparatus 110, and, to avoid repetition, explanation of them will not be made below.

The control unit 121 is a CPU. The control unit 121 controls the respective components of the automatic vending machine 120 and performs various arithmetic processes in accordance with programs stored in the storage unit 122. The control unit 121 also communicates with the control unit 111 of the image forming apparatus 110 via the communication unit 126, and transmits various instructions, setting values, and the like for controlling the image forming apparatus 110. The control unit 121 also serves as a display control device that causes the operation display unit 125 to display various screens, and controls switching of the screens to be displayed.

The storage unit 122 includes a ROM that stores various programs and various kinds of data in advance, a RAM that serves as a work area to temporarily store programs and data, and a hard disk or the like that stores various programs and various kinds of data. The storage unit 122 also stores the threshold value to be used for determining whether to switch the screen display in accordance with the type of the operation being performed. The storage unit 122 further stores the start-up time that is the waiting time between switching to a new screen and start-up of the device to be used through the new screen. As for the threshold value and the value of the start-up time to be stored in the storage unit 122, a user or the system manager can select appropriate values.

The stock unit 123 is stocked with the products to be sold through the automatic vending machine 120, and discharges the products in stock in accordance with instructions from the control unit 121.

The heating/cooling unit 124 includes a heating unit and a cooling unit that are thermally in contact with the stock unit 123, and heats or cools the products stored in the stock unit 123.

The operation display unit 125 is a touch-panel display, for example. The operation display unit 125 displays various kinds of information, and receives various inputs from users. The operation display unit 125 displays not only the screen for controlling the automatic vending machine 120 but also the screen for controlling the image forming apparatus 110. For example, when an instruction for a start or a stop is received from a user while the operation display unit 125 displays the screen for controlling the image forming apparatus 110, the control unit 121 of the automatic vending machine 120 transmits the received instruction to the image forming apparatus 110. In accordance with the instruction transmitted from the automatic vending machine 120, the control unit 111 of the image forming apparatus 110 controls the image forming apparatus 110. Thus, the user can operate the image forming apparatus 110 by giving an instruction to the image forming apparatus 110 through the operation display unit 125 of the automatic vending machine 120.

In this embodiment, the automatic vending machine 120 receives an operation for switching the display on the operation display unit 125 between the screen for controlling the automatic vending machine 120 and the screen for controlling the image forming apparatus 110. As the operation for switching the screen display, a flicking operation is performed on the touch panel. A flicking operation on the touch panel is performed to slide the touched portion a certain distance. Whether to switch the display is determined based on a result of a check made to determine whether the “level” of the operation for switching the display satisfies a criterion in the form of a predetermined threshold value. In a case where the operation for switching the display is a flicking operation, for example, the level of the operation is determined by the sliding distance over which the touched portion is slidably moved by the flick operation. The criterion in the form of a threshold value may be whether the level of the operation is larger than the threshold value or is smaller than the threshold value, for example. In this embodiment, the screen display is switched when the sliding distance in the flicking operation is longer than a predetermined threshold value. The switching of the screen display will be described later in detail.

The image forming apparatus 110 and the automatic vending machine 120 may each include one or more components in addition to the above described components, or may not include one or more of the above described components.

<Switching the Screen Display on the Operation Display Unit 125>

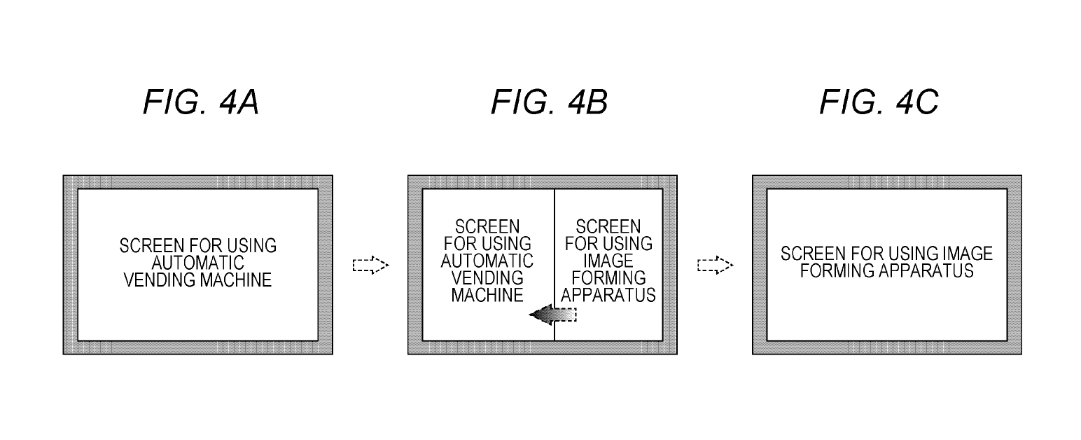

FIGS. 4A to 4C are diagrams for explaining an example of a screen display switching method.

As shown in FIG. 4A, the screen for using the automatic vending machine 120 is displayed on the operation display unit 125. A user can use various functions of the automatic vending machine 120 by pressing buttons or the like shown on this screen.

When a flicking operation from right to left in the drawing is performed while the screen shown in FIG. 4A is displayed, the screen for using the automatic vending machine 120 slides to the left, and the screen for using the image forming apparatus 110 appears sliding from the right, as shown in FIG. 4B. If the sliding distance or speed or the like in the flicking operation exceeds a predetermined threshold value, the screen shown in FIG. 4B changes to the screen shown in FIG. 4C, and the screen for using the image forming apparatus 110 is displayed on the operation display unit 125. In this manner, the display is switched from the screen shown in FIG. 4A to the screen shown in FIG. 4C. If the sliding distance or speed or the like in the flicking operation does not exceed the predetermined threshold value, the screen shown in FIG. 4B returns to the screen shown in FIG. 4A, or the screen shown in FIG. 4A remains on the display. As a result, the screen dos not change to the screen shown in FIG. 4C. That is, the screen display is not switched.

<Outline of a Display Control Process in the Display System>

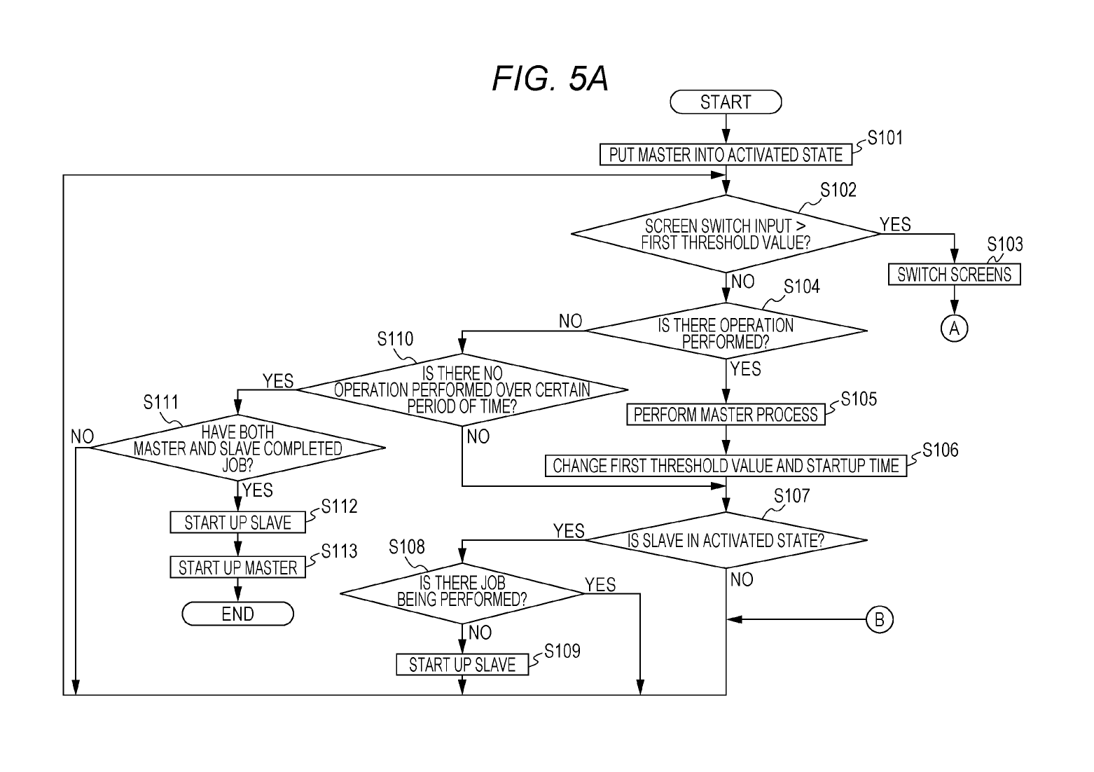

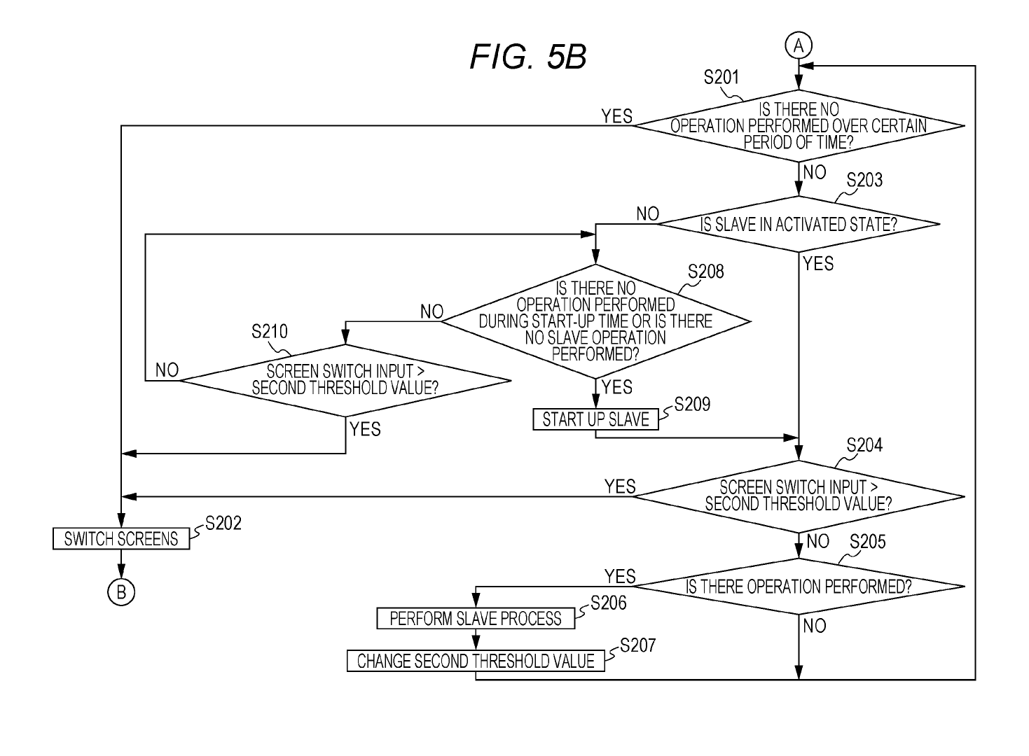

FIG. 5A is a flowchart showing the procedures in a display control process to be performed in the display system. FIG. 5B is a flowchart continuing from FIG. 5A. The algorithm shown in the flowcharts in FIGS. 5A and 5B is stored as a program in the storage unit 112 of the image forming apparatus 110 or in the storage unit 122 of the automatic vending machine 120, and is to be executed by the control unit of each apparatus. The process shown in FIG. 5A is the process to be performed while the screen for using the automatic vending machine 120 is displayed, and the process shown in FIG. 5B is the process to be performed while the screen for using the image forming apparatus 110 is displayed. In FIGS. 5A and 5B, “master” means the automatic vending machine 120, which is the master apparatus of this embodiment, and “slave” means the image forming apparatus 110, which is the slave apparatus of this embodiment.

In this embodiment, a process flow in which a user uses the image forming apparatus 110 after using the automatic vending machine 120 is described as an ideal process flow.

As shown in FIG. 5A, when power is applied to the automatic vending machine 120 as the master apparatus, the automatic vending machine 120 enters an activated state (step S101). The screen for using the automatic vending machine 120 is displayed on the operation display unit 125 of the automatic vending machine 120. While in an activated state, the automatic vending machine 120 can receive an operation for switching the screen display on the operation display unit 125. In the example described in this embodiment, a flicking operation is described as an example operation for switching the screen display.

The automatic vending machine 120 then determines whether the level of the operation for switching the screen display is higher than a first threshold value (step S102). Specifically, the control unit 121 of the automatic vending machine 120 determines whether the value indicating the level of a received flicking operation on the operation display unit 125 is greater than the first threshold value stored beforehand into the storage unit 122. The value indicating the level of the flicking operation is the sliding distance in the flicking operation, for example. If the sliding distance in the flicking operation is longer than the first threshold value, the level of the operation is determined to be higher than the first threshold value. If the sliding distance in the flicking operation is equal to or shorter than the first threshold value, the level of the operation is determined not to be higher than the first threshold value.

If the level of the operation is higher than the first threshold value (YES in step S102), the automatic vending machine 120 switches the screen display on the operation display unit 125 (step S103). Specifically, the control unit 121 of the automatic vending machine 120 serves as a display switching unit, and switches the display on the operation display unit 125 from the screen for using the automatic vending machine 120 to the screen for using the image forming apparatus 110, as shown in FIGS. 4A to 4C. In this embodiment, the screen for using the image forming apparatus 110 is provided by the control unit 121 of the automatic vending machine 120. With this, screen switching can be promptly performed. As a result, even if the image forming apparatus 110 is not in an activated state, the screen for using the automatic vending machine 120 can be displayed to receive an instruction from a user. After the screen display is switched in step S103, the automatic vending machine 120 moves on to the procedure in step S201 shown in FIG. 5B. The procedure in step S201 and the procedures that follow will be described later.

If the level of the operation is equal to or lower than the first threshold value (NO in step S102), on the other hand, the automatic vending machine 120 determines whether an operation for using the automatic vending machine 120 has been performed (step S104). Specifically, the control unit 121 of the automatic vending machine 120 determines whether an operation such as pressing a button for using a function of the automatic vending machine 120 has been received through the screen displayed on the operation display unit 125.

If an operation for using the automatic vending machine 120 has been performed (YES in step S104), the automatic vending machine 120 performs a process such as dispensing a product, which is one of the functions of the automatic vending machine 120 (step S105).

The automatic vending machine 120 then changes the first threshold value and the start-up time (step S106). Specifically, after the process in the automatic vending machine 120 is completed in step S104, the control unit 121 of the automatic vending machine 120 serves as a setting unit, and changes the first threshold value and the start-up time stored in the storage unit 122. The first threshold value is the value to be used in step S102 to determine whether the screen display is to be switched based on the level of a flicking operation. The start-up time is the value indicating the waiting time between switching of the screen display to the screen for using the image forming apparatus 110 and automatic start-up of the image forming apparatus 110. In this embodiment, the first threshold value is changed so that switching of the screen display is facilitated. Specifically, the first threshold value is changed to a smaller value than the value used before the process in the automatic vending machine 120 is completed in step S104. The start-up time is changed so that the waiting time before start-up becomes shorter. Specifically, the start-up time is changed to a smaller value than the value used before the process in the automatic vending machine 120 is completed in step S104. The process to change the first threshold value and the process to change the start-up time will be described later in detail.

The automatic vending machine 120 next determines whether the image forming apparatus 110 as the slave apparatus is in an activated state (step S107).

If the image forming apparatus 110 is not in an activated state (NO in step S107), the automatic vending machine 120 returns to step S102.

If the image forming apparatus 110 is in an activated state (YES in step S107), the automatic vending machine 120 determines whether the image forming apparatus 110 is performing a job (step S108).

If the image forming apparatus 110 is performing a job (YES in step S108), the automatic vending machine 120 returns to step S102.

If the image forming apparatus 110 is not performing any job (NO in step S108), the automatic vending machine 120 stops the operation of the image forming apparatus 110 (step S109), and returns to step S102.

If the result of the determination in step S104 shows that any operation for using the automatic vending machine 120 has not been performed (NO in step S104), the automatic vending machine 120 determines whether it is in a non-operated state in which any operation is not to be performed until after a certain period of time passes (step S110).

If the automatic vending machine 120 is not in a non-operated state (NO in step S110), or if some operation is performed within a certain period of time, the automatic vending machine 120 moves on to step S107.

If the automatic vending machine 120 is in a non-operated state (YES in step S110), the automatic vending machine 120 determines whether the automatic vending machine 120 and the image forming apparatus 110 as the slave apparatus have completed jobs (step S111).

If jobs have been completed (YES in step S111), the automatic vending machine 120 stops the operation of the image forming apparatus 110 (step S112). The automatic vending machine 120 then stops the operation thereof (step S113), and ends the process.

If there is a job yet to be completed (NO in step S111), the automatic vending machine 120 returns to step S102.

In step S102, a check is again made to determine whether the level of the operation for switching the screen display is higher than the first threshold value. If the first threshold value has been changed to a smaller value in step S105, chances are high that the level of the operation will be determined to be higher than the first threshold value. That is, after the process in the automatic vending machine 120 is completed, the screen display is switched more readily than before the process in the automatic vending machine 120 is completed. Thus, after the process in the automatic vending machine 120 is completed, the user can be guided to start a process in the image forming apparatus 110.

Next, the process shown in FIG. 5B is described.

As shown in FIG. 5B, the automatic vending machine 120 determines whether it is in a non-operated state for a certain period of time after the display was switched to the screen for using the image forming apparatus 110 in step S103 (step S201).

If the automatic vending machine 120 is in a non-operated state (YES in step S201), the automatic vending machine 120 switches the screen display on the operation display unit 125 (step S202). Specifically, the automatic vending machine 120 switches the display on the operation display unit 125 from the screen for using the image forming apparatus 110 to the screen for using the automatic vending machine 120. The automatic vending machine 120 then returns step S102 shown in FIG. 5A.

If the automatic vending machine 120 is not in a non-operated state (NO in step S201), the automatic vending machine 120 determines whether the image forming apparatus 110 is in an activated state (step S203).

If the image forming apparatus 110 is in an activated state (YES in step S203), the automatic vending machine 120 determines whether an operation for switching the screen display has been performed, and whether the level of the operation is higher than a second threshold value (step S204). The method of determining the level of the operation in step S204 is the same as the determination method used in step S102.

If an operation for switching the screen display has been performed, and the level of the operation is higher than the second threshold value (YES in step S204), the automatic vending machine 120 moves on to step S202. In step S202, the automatic vending machine 120 switches the display on the operation display unit 125 to the screen for using the automatic vending machine 120, and then returns to step S102 shown in FIG. 5A.

If any operation for switching the screen display has not been performed, or if the level of the operation is equal to or lower than the second threshold value (NO in step S204), the automatic vending machine 120 determines whether an operation for using the image forming apparatus 110 has been performed (step S205). Specifically, the control unit 121 of the automatic vending machine 120 determines whether an operation such as pressing a button for using a function of the image forming apparatus 110 has been received through the screen displayed on the operation display unit 125.

If any operation for using the image forming apparatus 110 has not been performed (NO in step S205), the automatic vending machine 120 returns to step S201.

If an operation for using the image forming apparatus 110 has been performed (YES in step S205), the automatic vending machine 120 transmits an instruction corresponding to the received operation to the image forming apparatus 110. In accordance with the instruction transmitted from the automatic vending machine 120, the image forming apparatus 110 performs a process such as printing, which is one of the functions thereof (step S206).

The automatic vending machine 120 then changes the second threshold value (step S207), and returns to step S201. Specifically, after the process in the image forming apparatus 110 is completed in step S206, the automatic vending machine 120 changes the second threshold value stored in the storage unit 122. The second threshold value is the value to be used in determining whether the screen display is to be switched based on the level of a flicking operation. In this embodiment, the second threshold value is changed so that switching of the screen display is facilitated. Specifically, in step S207, the second threshold value is changed to a smaller value than the value used before the process in the image forming apparatus 110 is completed in step S206.

If the image forming apparatus 110 is determined not to be in an activated state in step S203 (NO in step S203), the automatic vending machine 120 moves on to step S208.

The automatic vending machine 120 then determines whether it is in a non-operated state until after the start-up time passes or whether an operation for using the image forming apparatus 110 has been performed (step S208). Specifically, the automatic vending machine 120 determines whether it is in a non-operated state during the period between the time when the display on the operation display unit 125 is switched to the screen for using the image forming apparatus 110 and the time when the start-up time stored in the storage unit 122 has passed. The automatic vending machine 120 also determines whether an operation for using the image forming apparatus 110 has been performed.

If the automatic vending machine 120 is not in a non-operated state until after the start-up time passes, or if an operation for using the image forming apparatus 110 has been performed (YES in step S208), the automatic vending machine 120 transmits a start-up instruction to the image forming apparatus 110. In accordance with the start-up instruction transmitted from the automatic vending machine 120, the image forming apparatus 110 enters an activated state (step S209). If the value of the start-up time has been changed to a smaller value in step S106 in FIG. 5A, the image forming apparatus 110 is started up in a shorter time. That is, after the process in the automatic vending machine 120 is completed, the image forming apparatus 110 is started up in a shorter time than before the process in the automatic vending machine 120 is completed.

If the automatic vending machine 120 is not in a non-operated state until after the start-up time passes, and any operation for using the image forming apparatus 110 has not been performed (NO in step S208), the automatic vending machine 120 moves on to step S210.

The automatic vending machine 120 then determines whether an operation for switching the screen display has been performed, and whether the level of the operation is higher than the second threshold value (step S210). The method of determining the level of the operation in step S210 is the same as the determination method used in step S102.

If an operation for switching the screen display has been performed, and the level of the operation is higher than the second threshold value (YES in step S210), the automatic vending machine 120 moves on to step S202. In step S202, the automatic vending machine 120 switches the display on the operation display unit 125 to the screen for using the automatic vending machine 120, and then returns to step S102 shown in FIG. 5A.

If any operation for switching the screen display has not been performed, or if the level of the operation is equal to or lower than the second threshold value (NO in step S210), the automatic vending machine 120 returns to step S208.

<Threshold Value Changing Process>

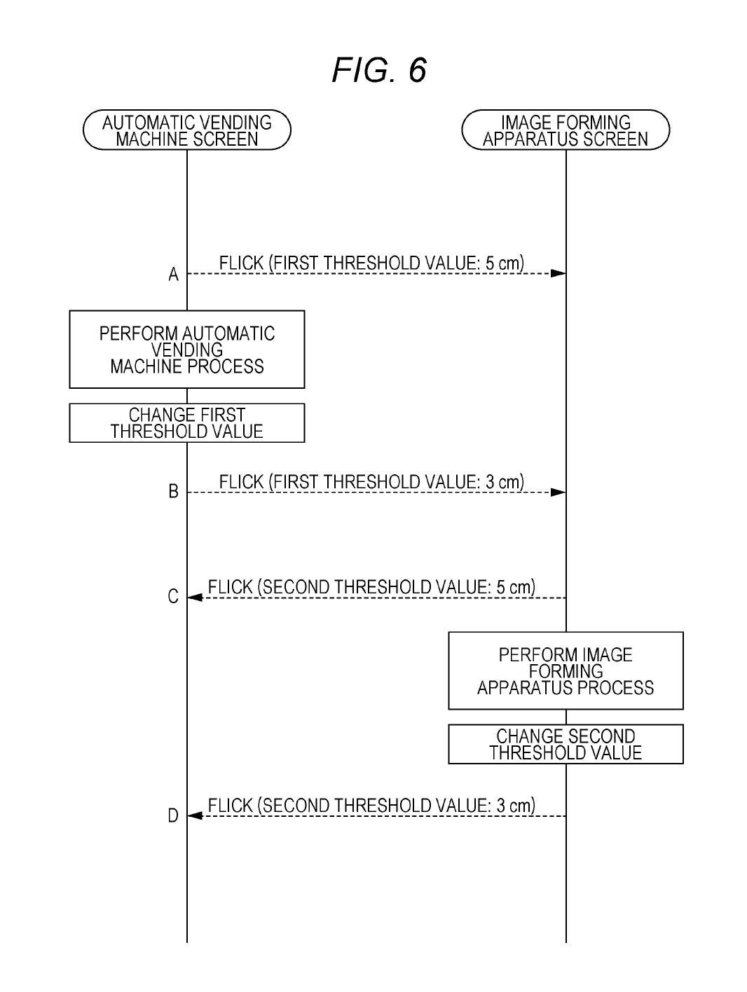

FIG. 6 is a diagram for explaining an example of a threshold value changing process.

In the example shown in FIG. 6, flicking operations are performed to switch the display between the automatic vending machine screen for using the automatic vending machine 120 and the image forming apparatus screen for using the image forming apparatus 110, as indicated by the arrows with dashed lines in the chart. The values indicating the levels of the flicking operations are the sliding distances in the flicking operations.

First, as shown in FIG. 6, the first threshold value is set at 5 cm at the point of time A before the process in the automatic vending machine 120 is completed. If the sliding distance in the flicking operation is longer than 5 cm, the display is switched from the automatic vending machine screen to the image forming apparatus screen.

At the point of time B, which is after the process in the automatic vending machine 120 is completed and the first threshold value is changed, the first threshold value is set at 3 cm. If the sliding distance in the flicking operation is longer than 3 cm at this point of time, the display is switched from the automatic vending machine screen to the image forming apparatus screen.

That is, after the process in the automatic vending machine 120 is completed, the screen display is switched with a shorter sliding distance, and accordingly, the screen display is switched more readily than before the process in the automatic vending machine 120 is completed.

Meanwhile, the second threshold value is set at 5 cm at the point of time C before the process in the image forming apparatus 110 is completed. If the sliding distance in the flicking operation is longer than 5 cm at this point of time, the display is switched from the image forming apparatus screen to the automatic vending machine screen.

At the point of time D after the process in the image forming apparatus 110 is completed, the second threshold value has been changed to 3 cm. If the sliding distance in the flicking operation is longer than 3 cm at this point of time, the display is switched from the image forming apparatus screen to the automatic vending machine screen.

That is, after the process in the image forming apparatus 110 is completed, the screen display is switched with a shorter sliding distance, and accordingly, the screen display is switched more readily than before the process in the image forming apparatus 110 is completed. The second threshold value for the display to switch from the image forming apparatus screen to the automatic vending machine screen at the point of time C is greater than the first threshold value for the display to switch from the automatic vending machine screen to the image forming apparatus screen at the point of time B. With this, the display can be prevented from switching back to the automatic vending machine screen after switching from the automatic vending machine screen to the image forming apparatus screen, and the user can be guided back to the automatic vending machine screen only after completing the process in the image forming apparatus 110.

As each threshold value for switching the screen display is changed in accordance with the progress of the process in each corresponding apparatus as described above, the user can be guided to an appropriate process flow.

<Start-Up Time Changing Process>

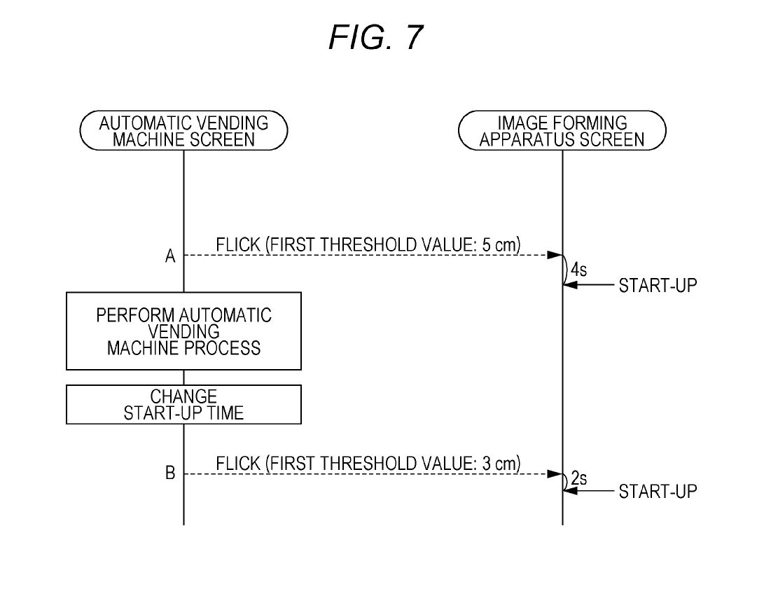

FIG. 7 is a diagram for explaining an example of the start-up time changing process.

In the example shown in FIG. 7, flicking operations are performed to switch the display between the automatic vending machine screen and the image forming apparatus screen, as indicated by the arrows with dashed lines in the chart. The image forming apparatus 110 is put into an activated state when a predetermined start-up time has passed since the display was switched to the image forming apparatus screen.

First, as shown in FIG. 7, the start-up time is set at four seconds at the point of time A before the process in the automatic vending machine 120 is completed. Because of this, the image forming apparatus 110 is put into an activated state after four seconds have passed since the display was switched to the image forming apparatus screen.

At the point of time B, which is after the process in the automatic vending machine 120 is completed, the start-up time has been changed to two seconds. Because of this, the image forming apparatus 110 is put into an activated state after two seconds have passed since the display was switched to the image forming apparatus screen.

That is, after the process in the automatic vending machine 120 is completed, the period of time between switching to the image forming apparatus screen and start-up of the image forming apparatus 110 is shorter than before the process in the automatic vending machine 120 is completed. As the start-up time for each apparatus after switching of the screen display is changed in accordance with the progress in the process in each corresponding apparatus as described above, user-friendliness can be increased while electricity is saved.

As described above, in the display system of this embodiment, each threshold value to be used in determining whether to switch the screen display based on the level of operation is set in accordance with progress of the process, and, when the level of the operation exceeds a threshold value, the screen display is switched. Thus, in an apparatus that performs various processes, operations for switching screens for using the various processes can be made to vary, and the user can be guided to an ideal process flow.

In the display system, the first threshold value for switching the display from the screen for using the automatic vending machine 120 to the screen for using the image forming apparatus 110 is changed so that the screen can be switched more readily after the automatic vending machine 120 is used than before the automatic vending machine 120 is used. Thus, a user can be unintentionally guided to use the image forming apparatus 110 after using the automatic vending machine 120.

In the display system, the second threshold value for switching the display from the screen for using the image forming apparatus 110 to the screen for using the automatic vending machine 120 is changed so that the screen can be switched more readily after the image forming apparatus 110 is used than before the image forming apparatus 110 is used. Thus, a user can be unintentionally guided to use the automatic vending machine 120 after using the image forming apparatus 110.

In the display system, a user or the manager or the like can change the first threshold value and the second threshold value. Thus, a user can be more flexibly guided to an appropriate process flow.

The display system puts the image forming apparatus 110 into an activated state when the display is switched from the screen for using the automatic vending machine 120 to the screen for using the image forming apparatus 110. With this, the image forming apparatus 110 is automatically started up when the image forming apparatus 110 is to be used after screen switching. Thus, user-friendliness can be increased while electricity is saved.

The display system also puts the image forming apparatus 110 into an activated state when a predetermined start-up time has passed since screen switching. With this, even if a user inadvertently switches screens, the display can be promptly switched back to the previous screen, and unnecessary start-up of the image forming apparatus 110 can be prevented. Thus, electricity can be more effectively saved. Further, the user does not need to stop the wrongly activated image forming apparatus 110. Thus, the user can be prevented from taking unnecessary trouble.

The display system also changes the predetermined start-up time after screens are switched in accordance with progress in the process being performed in the automatic vending machine 120. With this, the start-up time is changed in accordance with the operating state of the user. Thus, electricity can be more effectively saved, and user-friendliness can be increased.

In the display system, a user or the manager or the like can also change the start-up time. With this, the operating state of each apparatus can be more flexibly controlled. Thus, electricity can be more appropriately saved, and user-friendliness can be increased.

If the process in the automatic vending machine 120 has not been completed yet, the display system sets the start-up time at a greater value. If the process in the automatic vending machine 120 has been completed, the display system sets the start-up time at a smaller value. If the process in the automatic vending machine 120 has not been completed yet, the time from screen switching to start-up of the image forming apparatus 110 becomes longer. Thus, unnecessary start-up of the image forming apparatus 110 due to an incorrect operation can be more effectively prevented. If the process in the automatic vending machine 120 has been completed, the time from screen switching to start-up of the image forming apparatus 110 becomes shorter. Thus, the user can be guided to conduct the process in the image forming apparatus 110 after conducting the process in the automatic vending machine 120.

In a case where the screen for using the automatic vending machine 120 is set as the normal display screen, and any process is not performed over a certain period of time while the screen for using the image forming apparatus 110 is displayed, the display system switches the display to the screen for using the automatic vending machine 120. Thus, a user can be guided to an appropriate process flow so that the user uses the image forming apparatus 110 after using the automatic vending machine 120.

<Modifications>

The present invention is not limited to the above described embodiment, and various modifications may be made to it without departing from the scope of the claimed invention.

In the above described embodiment, the value indicating the level of a flicking operation is the sliding distance. However, the value indicating the level of a flicking operation is not limited to that. For example, some other value such as a sliding speed, time, or pressure may be used, or two or more values may be combined and be used in determining the level of a flicking operation.

In the above described embodiment, a flicking operation is performed as an operation for switching screens on the touch panel display, but the present invention is not limited to that. For example, touching operations such as a multi-point touching operation to be performed at several points, or various gestures may be performed as operations for switching screens.

In the above described embodiment, the operation display unit 125 has a touch panel display, buttons, and the like, but the present invention is not limited to that. Various other user interface devices may be used as the operation display unit 125. For example, the operation display unit 125 may be formed with cameras that detect lines of sight of a user, and receive an operation performed with the lines of sight of the user. In this case, the level of the operation may be determined by the speed of movement of the lines of sight (or eyeballs), the moving distance, the angle of movement, or the stationary time at a specific point, for example.

Alternatively, the operation display unit 125 may detect the voice of a user with a microphone, and receive an operation through the voice. In this case, the level of the operation is determined by the volume, the pitch, or the duration of the voice, or the contents of the voice obtained as a result of voice analysis, for example. Further, the operation display unit 125 may include a device that uses a motion capture technique to detect motion of a user with various cameras and sensors, and receive an operation through the motion of the user. In this case, the level of the operation is determined by the velocity, the size, or the distance of motion, or the meaning of a gesture obtained as a result of gesture recognition, for example. Alternatively, the operation display unit 125 may include a device such as a non-contact IC card reader or an infrared receiver for communicating with an external device, and receive an operation through communication with an external device. In this case, the level of the operation is determined by the type of a signal received from the external device, the reception intensity, or the reception time, for example. Further, the operation display unit 125 may include a device such as a sensor that obtains various biosignals including brain waves, and be capable of performing an operation using a biosignal. In this case, the level of the operation is determined by the type, the pattern, or the intensity of the biosignal, or various parameters, for example.

In the above described embodiment, the screen display is switched when the value indicating the level of an operation exceeds a threshold value. However, the present invention is not limited to that. For example, the screen display may be switched when the value indicating the level of an operation is smaller than a threshold value.

In the above described embodiment, each threshold value is switched between two values before and after a process is completed. However, the present invention is not limited to that. Each threshold value may be switched among three or more values in accordance with progress of a process.

In the above described embodiment, the screen for using the image forming apparatus 110 is provided by the automatic vending machine 120. However, the present invention is not limited to that. While the image forming apparatus 110 is in an activated state, the screen for using the image forming apparatus 110 may be provided by the image forming apparatus 110. In that case, even if the functions of the image forming apparatus 110 are changed, the automatic vending machine 120 will be less affected, since the screen for using the image forming apparatus 110 is provided by the image forming apparatus 110.

In the above described embodiment, start-up and suspension of the image forming apparatus 110 are controlled in accordance with the start-up time, for example. However, the control operation is not limited to start-up and suspension. In addition to start-up and suspension of the image forming apparatus 110, it is possible to control various operating states of the apparatus, such as execution in a standby mode, a sleep mode, or a power saving mode, and recovery from each mode.

In the above described embodiment, the display is switched to the screen for using the automatic vending machine 120, if any process is not performed over a certain period of time while the screen for using the image forming apparatus 110 is displayed. However, the certain period of time may be changed in accordance with progress of a process. If the process in the automatic vending machine 120 has not been completed yet, the certain period of time is shortened. If the process in the automatic vending machine 120 has been completed, the certain period of time is prolonged. Consequently, when the process in the automatic vending machine 120 has not been completed yet, the time before the display returns to the screen for using the automatic vending machine 120 becomes shorter. When the process in the automatic vending machine 120 has been completed, the time before the display returns to the screen for using the automatic vending machine 120 becomes longer. Thus, a user can be more effectively guided to an appropriate process flow.

In the above described embodiment, if the process in the automatic vending machine 120 has not been completed yet, the start-up time is prolonged. If the process in the automatic vending machine 120 has been completed, the start-up time is shortened. However, the start-up time may be shortened when the process in the automatic vending machine 120 has not been completed yet, and the start-up time may be prolonged when the process in the automatic vending machine 120 has been completed. This example will be described below in detail.

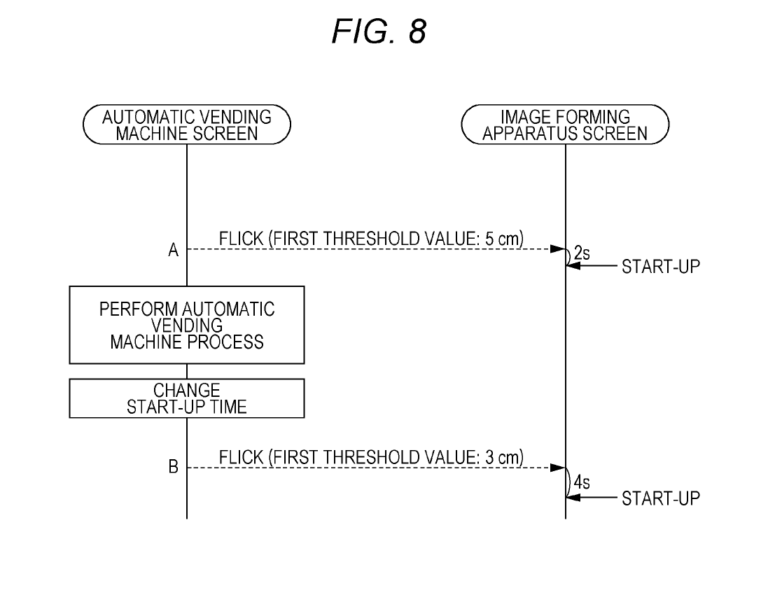

FIG. 8 is a diagram for explaining another example of the start-up time changing process.

As shown in FIG. 8, the start-up time before the image forming apparatus 110 is started up is set at two seconds at the point of time A before the process in the automatic vending machine 120 is completed. Meanwhile, the start-up time before the image forming apparatus 110 is started up is set at four seconds at the point of time B after the process in the automatic vending machine 120 is completed. The advantages of the settings are as follows. When the process in the automatic vending machine 120 has not been completed yet, the threshold value to be used in determining whether to switch screens is large. Therefore, to switch the display to the screen for using the image forming apparatus 110, it is necessary to perform an operation that exceeds the large threshold value. Where screens have been switched through such an operation, the user must have switched screens with a clear intent to use the image forming apparatus 110. In such a case, the time before the image forming apparatus 110 is started up after the screen switching is shortened, so that the user can promptly use the image forming apparatus 110. Thus, user-friendliness can be increased.

In the above described embodiment, screens are switched by sliding two screens from side to side as shown in FIGS. 4A to 4C. However, the present invention is not limited to that. For example, screens may be made to slide not only to the right and to the left, but also in any other direction. Further, screens may be switched not necessarily by sliding but by any other technique. Examples of screen switching methods will be described below.

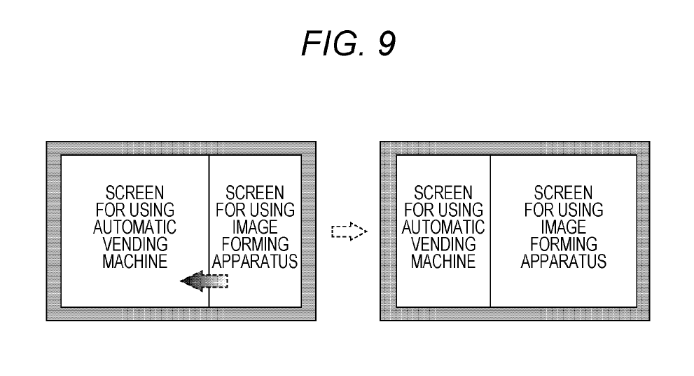

FIGS. 9 to 12C are diagrams for explaining other examples of screen display switching methods.

As shown in FIG. 9, screen switching may be performed by changing the proportion of the area occupied by each screen.

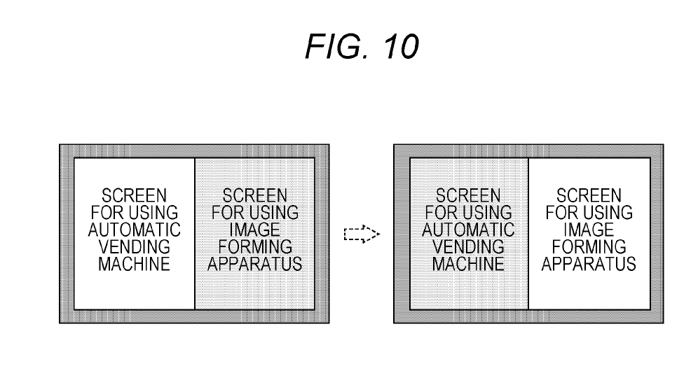

As shown in FIG. 10, each screen may switch indications as to whether operations can be accepted. For example, screen switching may be performed by switching between an active screen and an inactive screen, or by changing the luminance or chroma of each screen.

As shown in FIG. 11, screen switching may be performed by changing the anteroposterior relationship between the screens on the operation display unit 125, or by changing the proportion of the displayed portion to the non-displayed portion in each screen.

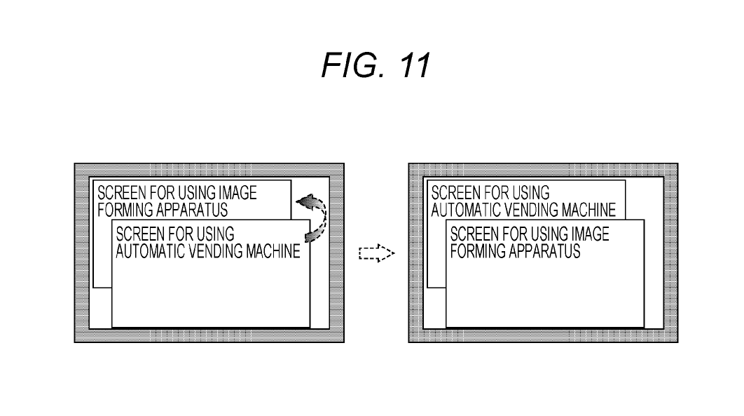

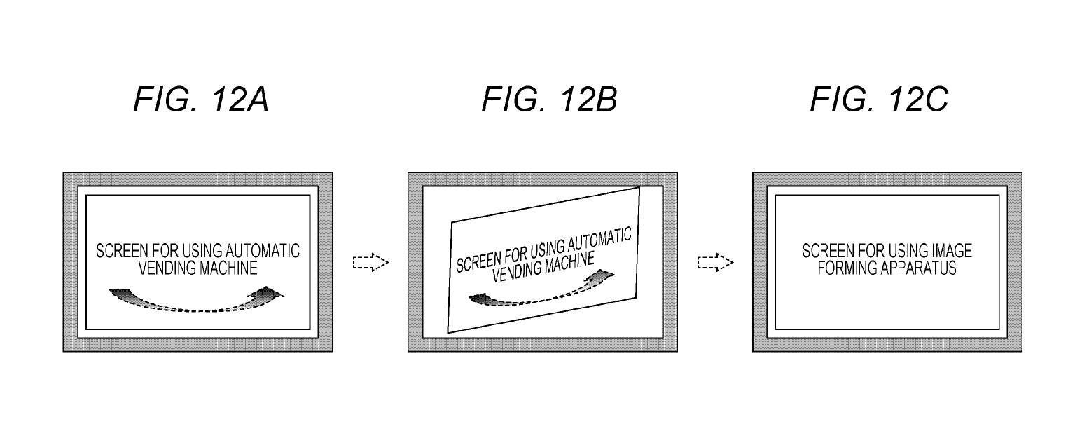

As shown in FIGS. 12A to 12C, screen switching may be performed by reversing the screen displayed on the operation display unit 125.

Further, a screen may be highlighted, and screen switching may be performed by highlighting another screen.

Screen switching may be performed gradually so that the transition can be seen. Alternatively, screen switching may be performed instantaneously so that screens are promptly switched.

In the above described embodiment, the display is switched between two screens for using two processes. However, the present invention is not limited to that. The above described embodiment may be applied in a case where the display is switched among three or more screens for using three or more processes.

### Second Embodiment

In the first embodiment, a display system is formed with the two apparatuses: the automatic vending machine 120 as the master apparatus, and the image forming apparatus 110 as the slave apparatus. However, the structure of a display system is not limited to that. The two apparatuses may not be in a master-slave relationship, but may be independent of each other in a parallel relationship. The apparatuses constituting a display system are not limited to an automatic vending machine and an image forming apparatus, but may be any electronic apparatuses. Further, a display system may be a single apparatus that has more than one function, for example. In that case, the respective screens for using two functions are switched on the display of the single apparatus. In a second embodiment, a display system is a single apparatus that has more than one function. The same components as those of the display system of the first embodiment are denoted by the same reference numerals used in the first embodiment, and explanation of them will not be made below.

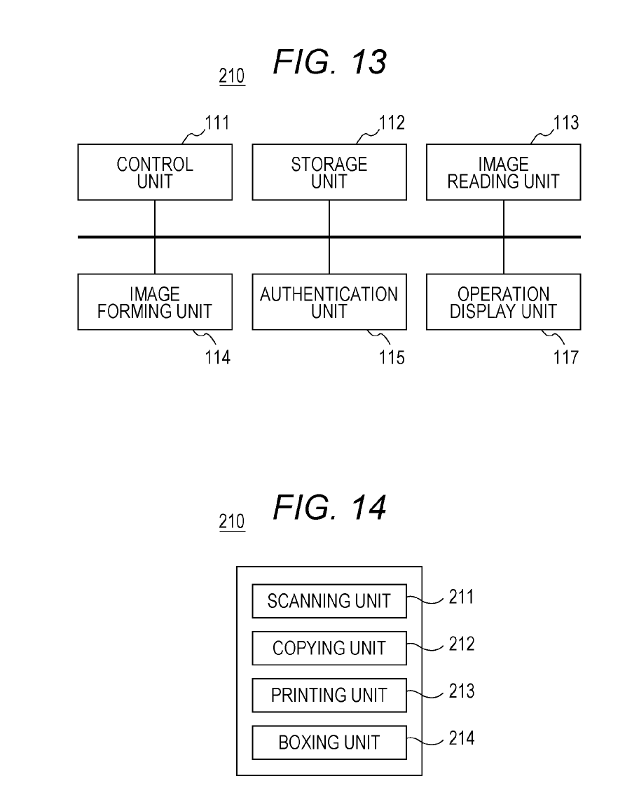

FIG. 13 is a block diagram showing the hardware configuration of the display system according to the second embodiment.

As shown in FIG. 13, the display system is an image forming apparatus 210 that includes a control unit 111, a storage unit 112, an image reading unit 113, an image forming unit 114, an authentication unit 115, and an operation display unit 117. The structure of the image forming apparatus 210 is basically the same as the structure of the image forming apparatus 110 of the first embodiment shown in FIG. 3, but differs from the structure of the image forming apparatus 110 only in including the operation display unit 117, instead of the communication unit 116.

The operation display unit 117 has the same structure as the operation display unit 125 in the automatic vending machine 120 of the first embodiment. The respective screens for using the respective functions of the image forming apparatus 210 are to be displayed on the operation display unit 117. The operation display unit 117 receives operations for switching the display between the respective screens, and operations for using the respective functions.

In this embodiment, the control unit 111 also serves as a display control device that causes the operation display unit 117 to display various screens, and controls switching of the screens to be displayed.

Next, the functions of the image forming apparatus 210 are described.

FIG. 14 is a block diagram showing the functional structure of the image forming apparatus shown in FIG. 13.

As shown in FIG. 14, the image forming apparatus 210 has functions including a scanning unit 211, a copying unit 212, a printing unit 213, and a boxing unit 214. Because of these functions, programs corresponding to the scanning unit 211, the copying unit 212, the printing unit 213, and the boxing unit 214 are stored in the storage unit 112 of the image forming apparatus 210. Each function of the image forming apparatus 210 is realized by the control unit 111 executing each corresponding program.

The scanning unit 211 has the scanning function of reading an original image with the image reading unit 113 and generating the image data corresponding to the original image.

The copying unit 212 has the copying function of copying an original image by generating image data from the original image in the image reading unit 113 and forming an image based on the image data on a paper sheet or the like in the image forming unit 114.

The printing unit 213 has the printing function of performing a print job or the like by generating image data based on print data included in the print job or the like and forming an image based on the image data on a paper sheet or the like in the image forming unit 114.

The boxing unit 214 has the boxing function of storing various kinds of image data and the like used in the image forming apparatus 210 into the storage unit 112 so that users can retrieve the image data and the like when necessary.

Next, a display control process to be performed in the display system of the second embodiment, or in the image forming apparatus 210, is described. In the example case described below, the display of the operation display unit 117 of the image forming apparatus 210 is switched from the screen for using the scanning function to the screen for using the boxing function.

The display control process to be performed in the display system of the second embodiment is basically the same as the display control process to be performed in the display system of the first embodiment shown in FIGS. 5A and 5B. In the second embodiment, the algorithm shown in the flowcharts in FIGS. 5A and 5B is stored as a program in the storage unit 112 of the image forming apparatus 210, and is to be executed by the control unit 111. In the second embodiment, “master” in FIGS. 5A and 5B corresponds to the scanning function, and “slave” corresponds to the boxing function.

As shown in FIG. 5A, the image forming apparatus 210 first puts the scanning function into an activated state, and causes the operation display unit 117 to display the screen for using the scanning function (step S101).

The image forming apparatus 210 then determines whether the level of the operation for switching the screen display is higher than a first threshold value (step S102). At this point of time, the first threshold value is a large value prior to change, and therefore, the level of the operation is not likely to be higher than the first threshold value. That is, the screen display is not readily switched. In this example, the level of the operation for switching the screen display is equal to or lower than the first threshold value (NO in step S102).

When an operation to perform a process based on the scanning function is performed (YES in step S104), the image forming apparatus 210 performs a scanning process with the scanning unit 211 (step S105). When the scanning process is completed, the image forming apparatus 210 changes the first threshold value and the start-up time (step S106).

After carrying out steps S107 to S109, the image forming apparatus 210 returns to step S102, and then determines whether the level of the operation for switching the screen display is higher than the first threshold value. If the first threshold value has been changed to a smaller value in step S105, chances are high that the level of the operation will be determined to be higher than the first threshold value. Specifically, after the process based on the scanning function is completed, the display is more readily switched to the screen for using the boxing function than before the process based on the scanning function is completed. Thus, after the process based on the scanning function is completed, the user can be guided to start a process based on the boxing function.

As shown in FIG. 5B, the image forming apparatus 210 determines whether it is in a non-operated state for a certain period of time after the display was switched to the screen for using the boxing function in step S103 (step S201).

If the image forming apparatus 210 is in a non-operated state (YES in step S201), the image forming apparatus 210 may switch the display of the operation display unit 117 to the screen for using the scanning function or to some other screen.

If the image forming apparatus 210 is not in a non-operated state (NO in step S201), the image forming apparatus 210 determines whether the boxing function is in an activated state, or whether the process based on the boxing function and the hardware such as the storage drive for the boxing function are in an activated state (step S203).

If the boxing function is in an activated state (YES in step S203), the image forming apparatus 210 determines whether an operation for switching the screen display has been performed, and whether the level of the operation is higher than a second threshold value (step S204). At this point of time, the second threshold value is a large value prior to change, and therefore, the level of the operation is not likely to be higher than the second threshold value. That is, the screen display is not readily switched. In this example, the level of the operation for switching the screen display is equal to or lower than the second threshold value (NO in step S204).

When an operation to perform a process based on the boxing function is performed (YES in step S205), the image forming apparatus 210 performs a storing process or the like based on the boxing function with the boxing unit 214 (step S206). When the process based on the boxing function is completed, the image forming apparatus 210 changes the second threshold value (step S207).

If the boxing function is not in an activated state (NO in step S203), the image forming apparatus 210 determines whether it is in a non-operated state until after a predetermined start-up time passes, or whether an operation for using the boxing function has been performed (step S208).

If the image forming apparatus 210 in a non-operated state until after the start-up time passes, or if an operation for using the boxing function has been performed (YES in step S208), the image forming apparatus 210 puts the boxing function into an activated state, and then moves on to step S204.

If the image forming apparatus 210 is not in a non-operated state until after the start-up time passes, and any operation for using the boxing function has not been performed (NO in step S208), the image forming apparatus 210 moves on to step S210.

The image forming apparatus 210 then determines whether an operation for switching the screen display has been performed, and whether the level of the operation is higher than the second threshold value (step S210).

If an operation for switching the screen display has been performed, and the level of the operation is higher than the second threshold value (YES in step S210), the image forming apparatus 210 moves on to step S202. In step S202, the image forming apparatus 210 switches the display on the operation display unit 117 to the screen for using the scanning function, and then returns to step S102 shown in FIG. 5A.

If any operation for switching the screen display has not been performed, or if the level of the operation is equal to or lower than the second threshold value (NO in step S210), the image forming apparatus 210 returns to step S208.

As described above, in the display system of the second embodiment, a single apparatus that is capable of conducting two or more processes through the operation display unit 117 changes a threshold value for switching screens and the start-up time in accordance with progress of each process. As a result, the user can be guided to an ideal process flow.

The structures and the methods for conducting various processes in the display systems according to the above described embodiments can be obtained through a special-purpose hardware circuit or a programmed computer. The above described programs may be provided via computer-readable recording media such as flexible disks and CD-ROMs, or may be delivered online via a network such as the Internet. In this case, the programs recorded in a computer-readable recording medium are normally transferred to and stored into a storage unit such as a hard disk. Alternatively, the above described programs may be provided as application software, or may be incorporated as a function of a display system into the software of an apparatus.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A display control method implemented in a system capable of conducting two or more processes on a single display unit, the display control method comprising:
receiving an operation for switching a screen display between screens for using the respective processes;
setting a threshold value in accordance with progress of each corresponding one of the processes, the threshold value being for determining whether to switch the screen display in accordance with a level of the operation; and
switching the screen display when the level of the operation received satisfies a criterion corresponding to the threshold value.

2. The display control method according to claim 1, wherein changing the threshold value for switching the screen display from a screen for using one process to a screen for using another process, to enable the screen display to be switched more readily after the one process is used than before the one process is used when setting the threshold value.

3. The display control method according to claim 1, further comprising receiving a change of the threshold value from a user.

4. The display control method according to claim 1, further comprising changing an operating state of an apparatus performing a process to be used through a screen after the switching of the screen display in the display switching.

5. The display control method according to claim 4, wherein changing the operating state of the apparatus after a predetermined time has passed since the switching of the screen display.

6. The display control method according to claim 5, further comprising setting the predetermined time in accordance with progress of the process.

7. The display control method according to claim 5, further comprising receiving a change of the predetermined time from a user.

8. The display control method according to claim 6, wherein setting the predetermined time at a smaller value after the process to be used through the screen prior to the switching is performed than before the process to be used through the screen prior to the switching is performed.

9. The display control method according to claim 6, wherein setting the predetermined time at a greater value after the process to be used through the screen prior to the switching is performed than before the process to be used through the screen prior to the switching is performed.

10. The display control method according to claim 1, wherein switching of the screen display includes at least one of changing an area occupied by each screen on the display unit, changing permission of reception of an operation through each screen, highlighting a specific screen, changing luminance of a specific screen, and changing a positional relationship between a specific screen and another screen.

11. The display control method according to claim 1, wherein the operation includes at least one of an operation with a touch input or a flick input on a touch panel, an operation with a line of sight, an operation with voice, an operation with motion capture, an operation with hardware keys, and an operation through communication with an external electronic device.

12. The display control method according to claim 1, wherein switching the screen display to a screen for using one process, when the screen for using the one process is set as a normal display screen, and any process is not performed over a certain period of time while the screen for using another process is displayed.

13. A non-transitory recording medium storing a computer readable program for causing a computer to implement the display control method of claim 1.

14. A display control device for controlling a system capable of conducting two or more processes on the same display unit, the display control device comprising:
a processor configured to the following process;
receiving an operation for switching a screen display between screens for using the respective processes;
setting a threshold value in accordance with progress of a process, the threshold value being for determining whether to switch the screen display in accordance with a level of the operation; and
switching the screen display when the level of the operation received satisfies a criterion corresponding to the threshold value.
